(19) United States
(12) Patent Application Publication
(10) Pub. No.: US 2004/0195238 A1
(43) Pub. Date: Oct. 7, 2004

(54) Hinged pot cover

(75) Inventor: Francis Thomas Brija, Naperville, IL (US)

Correspondence Address: Frederick B. Ziesenheim, Esq., Webb Ziesenheim Logsdon Orkin & Hanson, P.C., 700 Koppers Building, 436 Seventh Avenue, Pittsburgh, PA, 15219, US

(73) Assignee: Spring USA Corporation

(21) Appl. No.: 10/618,870

(22) Filed: Jul. 14, 2003

Related U.S. Application Data
(60) Provisional application No. 60/459,520, filed on Apr. 1, 2003.

(51) Int. Cl. B65D 51/18; A47J 36/00

(52) U.S. Cl. 220/254.3; 220/912

(57) ABSTRACT

A hinged cover for a cooking utensil comprising a cover body having a cutout portion, a hinged section fitted within the cutout portion and pivotally attached to the cover body. The cover body and hinged section have circumferential perimeters which, when combined, define a total circumference of the hinged cover, wherein the perimeter of the hinged section is less than 50% of the total circumference of the hinged cover to prevent the cover from falling into the utensil when the hinged section is raised. Access can be gained to the cooking utensil by raising the hinged cover for removing or adding food products to the interior of the utensil without removing or otherwise displacing the cover from the cooking utensil.

### CROSS-REFERENCE TO RELATED APPLICATION

This application claims priority on U.S. Provisional Patent Application No. 60/459,520 filed Apr. 1, 2003.

### BACKGROUND OF THE INVENTION

1. Field of the Invention

The present invention relates to hinged covers for soup or stock pots and is particularly useful as a lid or cover for a commercial, self-service soup pot, hereinafter sometimes referred to collectively as a “cooking utensil”.

2. Description of Related Art

It is well-known in the cooking art and in the food service art generally that when a lid or cover is removed from a heated pot, that hot, condensed liquid is usually present on the underside of the lid when it is removed from the pot. If care is not taken, the hot liquid from the lid can burn or scald the person removing the lid and/or drip onto the cooking surface of the range or stove or serving station to cause an unsightly situation. It is, of course, desirable to keep the cover on a soup or stock pot in order to maintain the heat and liquid levels in the pot.

In commercial self-serve soup pots, as a result of health regulations, it is also necessary that the serving ladle remain in the pot while the lid is in place. In such self-serve soup pots, it is known to provide a soup pot cover having a notched-out portion at a perimeter of the cover to accommodate the elongated stem or handle of the serving ladle when the cover is in place. It is also known to provide a cover for commercial soup pots which are hinged along a hemispheric axis of the lid to permit the ladling of soup from the pot while the hinged portion of the lid is pivoted back. This prior art style of hinged pot cover causes problems in that the entire cover can fall into the pot of soup if it is not carefully manipulated during use. Of course, when this occurs, the soup must be replaced, requiring delays in the service and added expense in replacement.

My invention solves the above problems in the prior art by providing a hinged pot cover which is easy to use, cosmetically attractive, and which is designed to remain stably on the pot while in use. The hinged pot cover of the present invention is particularly suited for use in a commercial self-serve soup pot in conjunction with a serving ladle. The present invention provides a hinged pot cover which remains stably on the pot while the hinged section is raised to provide access to the interior of the pot for soup ladling or for the addition of soup or stock.

### SUMMARY OF THE INVENTION

Briefly stated, the present invention is directed to a lid or cover for a stock pot or soup pot or crock pot or the like. The cover comprises a cover body and a hinged section cut out from the body and pivotally connected to the cover body. The cover body preferably has a circular shape with a cut-out portion for the hinged section. The hinged section has a perimeter which is coextensive with the perimeter of the cover body. The hinged section is generally pie-shaped, i.e., in the form of a truncated wedge, with a flat edge formed at its narrowed dimension. The flat edge of the hinged section is pivotally attached with a hinge connector to the cover body, preferably along a portion of a diameter of the cover. The side edges of the hinged section diverge outwardly from the hinged flat edge to the rounded perimeter edge thereof. The perimeter of the hinged section also preferably has a notched cutout formed therethrough to accommodate the elongated end of a serving ladle. The hinged section also has a handle affixed thereto to permit the user to lift the hinged section upwardly from the pot and to pivot it backwardly onto the cover body as well as to then lower it. In the raised position, soup, for example, can be ladled from the pot and/or additional soup or stock can be added to the pot without removing the cover body from the pot.

The perimeter of the hinged section is less than 50% of the circumferential dimension of the entire cover (cover body+hinged section), preferably between about ¼ to ⅓ thereof, and more preferably, slightly more than ¼ the circumferential dimension of the entire cover. In this manner, the cover body rests securely on the top edge of the pot and cannot fall into the pot.

### BRIEF DESCRIPTION OF THE DRAWINGS

FIG. 1 is a perspective view of the hinged pot cover of the present invention with the hinged section closed;

FIGS. 2-4 are perspective views of the hinged pot cover of FIG. 1 at various angles with the hinged section raised; and

FIG. 5 is a perspective plan view of a further presently preferred embodiment of the hinged pot cover of the invention.

### DETAILED DESCRIPTION OF THE INVENTION

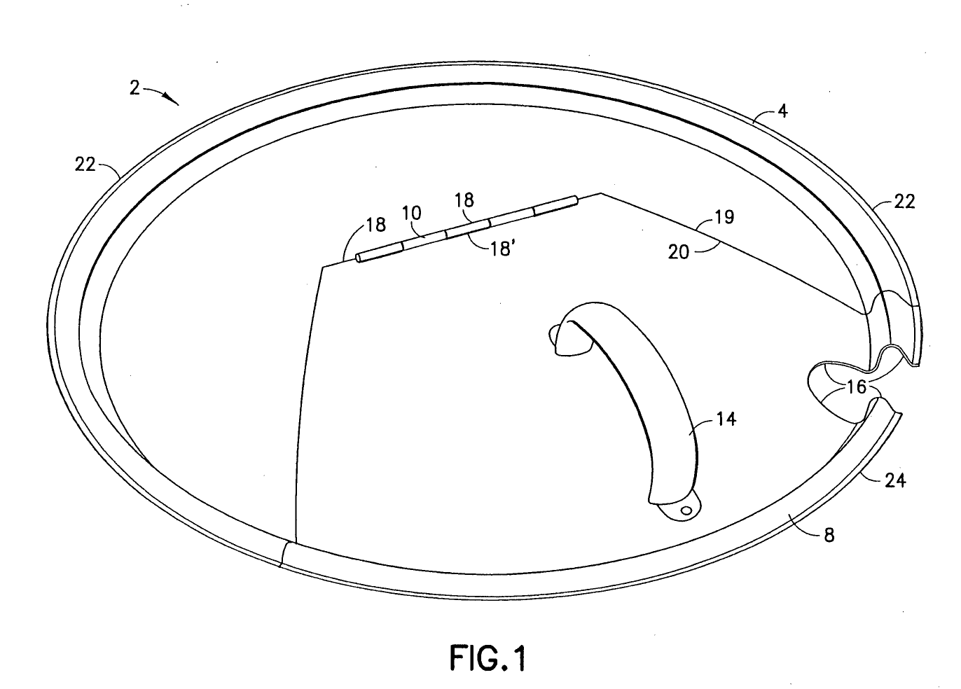

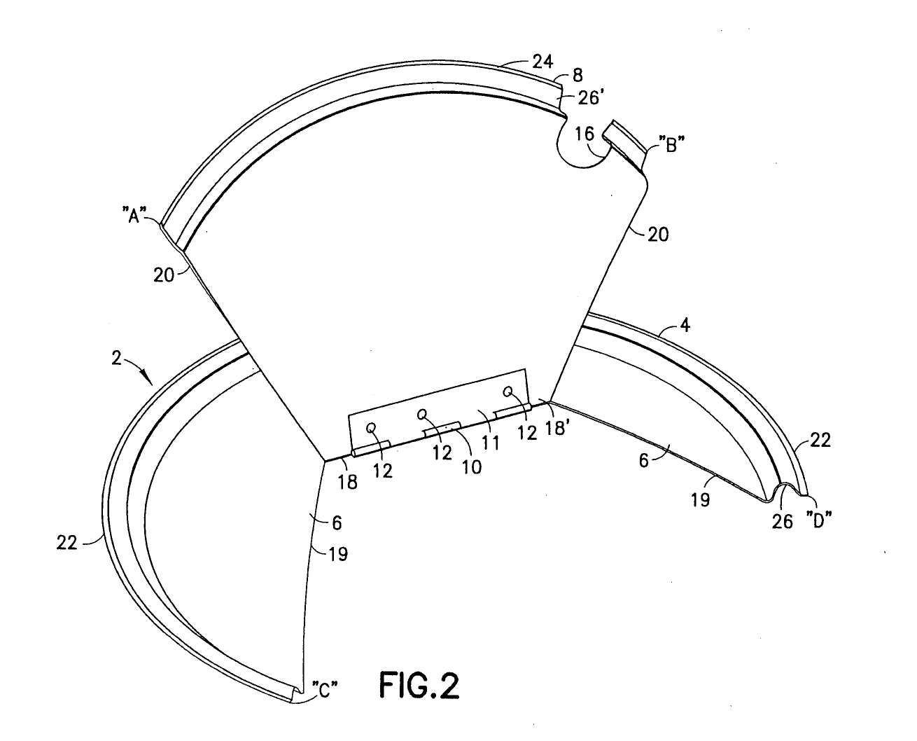

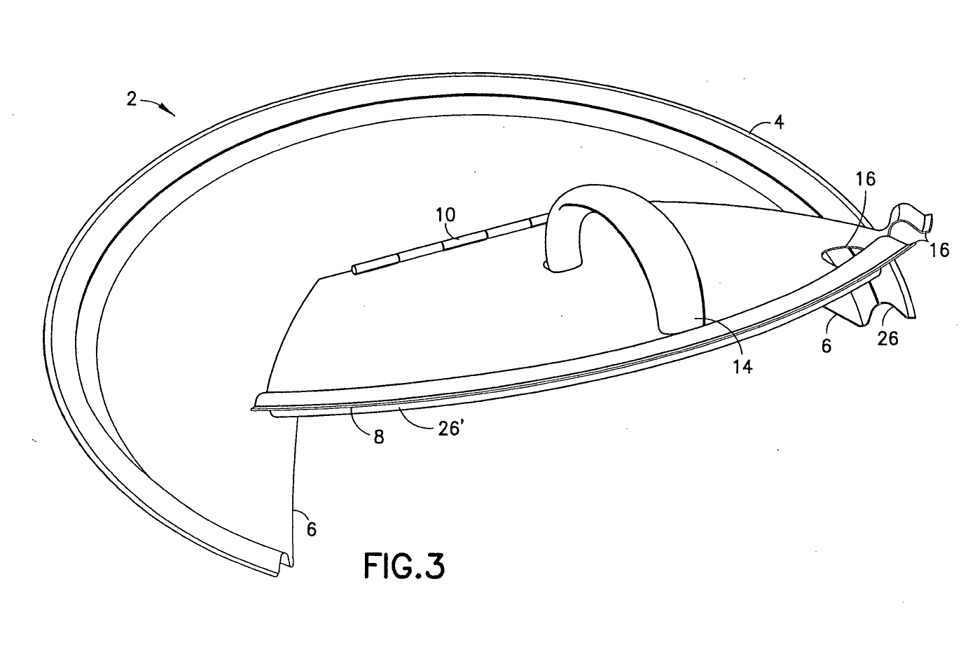

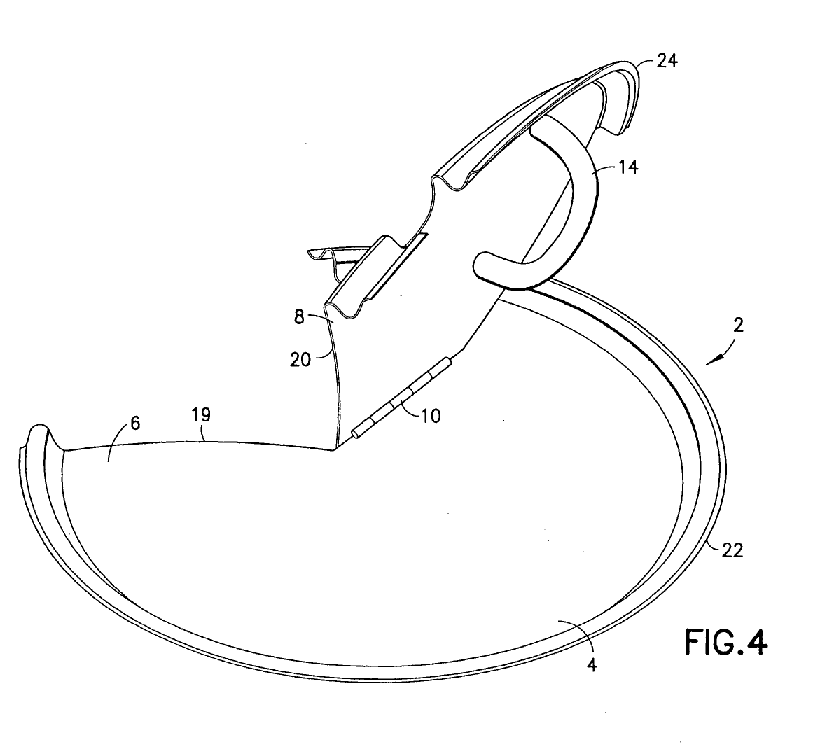

The hinged cover of the invention is identified generally in FIGS. 1-4 by reference numeral 2. The hinged cover 2 comprises a cover body 4 which is in the shape of a lid or cover for a conventional stock pot, soup pot, crockpot or like cooking utensil (not shown). The cover body 4 has a cutout portion 6 formed therein. The cutout portion 6 has a hinged section 8 of nearly identical shape fitted therein by way of a hinge 10. As perhaps best seen in FIG. 2, the hinge 10 includes hinge flanges 11 which are attached by spot welds 12 to the hinged section 8 and the cover body 4.

The hinged section 8 also includes a handle 14 attached thereto to permit the user to raise and lower the hinged section 8 to gain access to the interior of the soup or stock pot. The hinged section 8 may also optionally contain a notched cutout 16 formed in its perimeter 24 to accommodate the elongated handle of a ladle, for soup service, for example.

As stated above, the cutout portion 6 and the hinged section 8 have substantially the same shapes at least on three sides. The cutout portion 6 and hinged section 8 are somewhat pie-shaped, similar to a truncated wedge in configuration. The cutout portion 6 of the cover body 4 has a flat edge 18 formed along a central portion of the diameter of the cover body 4, FIG. 1. The hinged section 8 also has a flat edge 18′ formed therein which substantially matches the dimension of edge 18 although slightly smaller by several thousands of an inch so that the hinged section 8 fits closely within the opening of the cutout portion 6. A close fit is desired so that cooking vapors do not escape as would otherwise occur if gaps were present between the side edges 19 of the cutout portion 6 and the side edges 20 of the hinged section 8. The side edges 19 and 20 diverge outwardly from the respective flat edges 18 and 18′ to perimeter 24 so as to define the pie-shaped configuration to the cutout portion 6 and hinged section 8.

The hinged section 8 has an outer edge at perimeter 24 which extends from point A to point B in FIG. 2. The cover body 4 has an outer perimeter 22 extending from point C to point D, also shown in FIG. 2. In order to overcome the problems encountered in prior art hinged covers, the dimension A-B, which represents the linear dimension of outer perimeter 24 of the hinged section 8, is less than 50% of the total perimeter 22 of the cover body 4, plus the perimeter of the cutout portion 6 represented by the summation of dimensions (A to B)+(C to D), hereinafter referred to as the “total circumference”. Hence, the dimension A-B is 50% or less than the total circumference and, still more preferably, dimension A-B is between about ¼ to about ⅓ of the total circumference. In this manner, the hinged cover 2 will remain atop the soup pot or the like in a stable manner when the hinged section 8 is raised so as not to fall into the pot of soup as is sometimes the case with prior art hinged lids.

The outer edge perimeters 22 and 24 of the cover body 4 and hinged section 8 are also formed with an inverted U-shaped lip 26 and 26′, respectively, which provide a stable seat and vapor seal with an upper edge of the stock or soup pot (not shown).

The hinged cover 2 is formed in a conventional manner by stamping a round blank of metal, preferably a 300 series stainless steel such as 304 stainless steel, and then drawing the blank with appropriate tooling to form the full, uncut cover shape. The hinged section 8 may then be punched or otherwise cut from the formed cover, leaving the cutout portion 6 formed in the cover body 4. The punched-out hinged section 8 previously removed is then reattached to the cover body 4 by way of the hinge 10 as described above. Since the hinged section 8 and cover body 4 have been both formed in the same drawing operation, their shapes and contours are closely matched to ensure a pleasing cosmetic appearance.

It is, however, also contemplated that the cover body 4 and hinged section 8 can be formed separately so as to dispense with the need for a separate hinge assembly 10. In this embodiment, the hinge fingers would be formed integrally with the cover body 4 and with the hinged section 8 during the separate stamping and forming operations. The integral hinge fingers would then be bent into a rounded configuration and then intermeshed with the opposed fingers of one another. A hinge pin would then be inserted into the through bore formed by the intermeshing rounded fingers to provide the integral hinge construction. As stated, this embodiment eliminates the need of a separate hinge assembly 10, as well as the need and expense of the hinge welding operation. The finished hinged cover 2 is also visually more attractive, since the spot welds 12 would no longer be present.

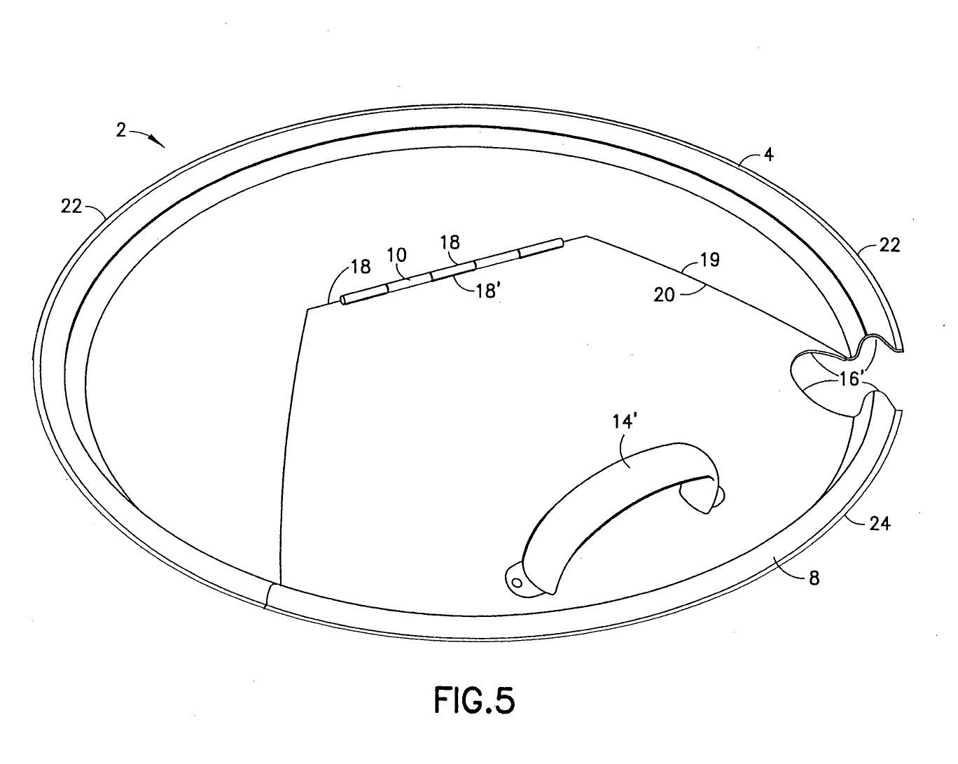

A slightly modified embodiment of the hinged cover 2 of the present invention is shown in FIG. 5. In this embodiment, the handle 14′ is oriented in a circumferential direction rather than the radially oriented handle 14 depicted in FIGS. 1-4. In addition, the embodiment of FIG. 5 includes a notched cutout portion 16′, which is formed partly along one side 20 of the hinged section 8 in order to make the punching operation easier.

The invention claimed is:

1. A hinged cover for a cooking utensil comprising a cover body having a cutout portion, a hinged section fitted within the cutout portion and pivotally attached to the cover body, said cover body and hinged section having circumferential perimeters which, when combined, define a total circumference of the hinged cover, wherein the perimeter of the hinged section is less than 50% of the total circumference of the hinged cover, whereby access can be gained to the cooking utensil by raising the hinged section for removing or adding food products to the interior of the utensil.

2. The hinged cover of claim 1 wherein the perimeter of the hinged section is between about ¼ to ⅓ of the total circumference of the hinged cover.

3. The hinged cover of claim 1 wherein the hinged section includes a handle affixed thereto for raising and lowering the hinged section.

4. The hinged cover of claim 3 wherein the cooking utensil is a stock or soup pot.

5. The hinged cover of claim 1 wherein the cooking utensil is a soup pot and wherein the perimeter of the hinged section has a notched cutout formed therein to accommodate a soup ladle when the hinged section is in a closed position and wherein the hinged cover includes a handle for raising and lowering the hinged section.

6. The hinged cover of claim 1 wherein the perimeters of the cover body and hinged section are formed in the shape of an inverted “U” adapted to form a secure seat and vapor seal with a top edge of the cooking utensil.

7. The hinged cover of claim 6 wherein the cooking utensil is a soup pot and wherein the perimeter of the hinged section has a notched cutout formed therein to accommodate a ladle and wherein the hinged section includes a handle for raising and lowering the hinged section and for lifting the hinged cover from the soup pot.

8. The hinged cover of claim 1 made from a 300 series stainless steel.

9. The hinged cover of claim 1 wherein the hinged section is pivotally attached to the cover body by way of a hinge assembly having hinge flanges attached to the hinged section and to the cover body.

10. The hinged cover of claim 1 wherein the hinged section is pivotally attached to the cover body by way of an integral hinge construction wherein a plurality of intermeshing rounded fingers of the hinge construction are integrally formed in the hinged section and in the cover body.
